(19) United States
(12) Patent Application Publication
(10) Pub. No.: US 2016/0024946 A1
(43) Pub. Date: Jan. 28, 2016

(54) ROTOR BLADE DOVETAIL WITH ROUND BEARING SURFACES

(71) Applicant: United Technologies Corporation, Hartford, CT (US)

(72) Inventor: Michael A. Weisse, Tolland, CT (US)

(73) Assignee: UNITED TECHNOLOGIES CORPORATION, Hartford, CT (US)

(21) Appl. No.: 14/800,157

(22) Filed: Jul. 15, 2015

Related U.S. Application Data
(60) Provisional application No. 62/027,333, filed on Jul. 22, 2014.

(51) Int. Cl. F01D 5/30; F01D 5/02; F01D 25/16; F01D 5/14

(52) U.S. Cl. CPC F01D 5/3007; F01D 5/141; F01D 5/02; F01D 25/16; F05D 2220/32; F05D 2240/30; F05D 2260/96; F05D 2260/30; F05D 2300/431

(57) ABSTRACT

A blade for use in a gas turbine engine, the blade having an airfoil portion and a dovetail root portion, wherein the dovetail root portion is dimensioned and configured to enable the blade to rotate within a shaped slot formed in a supporting hub of the engine about a center of rotation that extends parallel to a central axis of the hub in response to an impact force on the airfoil portion of the blade.

### CROSS-REFERENCE TO RELATED APPLICATION

This application claims the benefit of priority to U.S. Provisional Patent Application No. 62/027,333 filed Jul. 22, 2014, which is incorporated by reference herein in its entirety.

### BACKGROUND OF THE INVENTION

1. Field of the Invention

The subject invention relates generally gas turbine engines, and more particularly, a rotor blade with a dovetail root portion that has rounded bearing surfaces designed to reduce stress on the rotor blade that can result from a blade out condition or bird strike event.

2. Description of Related Art

A widely used type of a gas turbine engine is a turbofan. The distinguishing feature of the turbofan is an axial flow fan disposed in the forward section of the engine within an open duct. The fan is equipped with circumferentially arranged rotating blades and stationary vanes. Each fan blade comprises an airfoil portion and a dovetail-shaped root portion secured in a central fan hub. The fan hub includes a plurality of dovetail-shaped slots disposed circumferentially therein to engage the dovetail root portion of the blades, as disclosed for example in commonly assigned U.S. Pat. No. 8,573,947 to Klinetob et al.

Fan blades must be designed to withstand stress associated with a blade out condition (i.e., a blade failure) or from the ingestion of foreign objects during operation, such as bird strikes. During such an event, the bird speed at impact can be as high as 100 ft/sec, while the blade is turning at 1200 ft/sec. Designing fan blades for bird strike scenarios is challenging for at least two reasons. First, the fan blade must perform in a desired manner during the actual bird strike event at the impact sight. Second, the fan blade is subject to high bending and twisting loads near the neck of the root portion in response to the impact energy from the bird strike. The root loads are especially damaging if the fan blade is rigidly constrained to the supporting hub. High root loads can result in catastrophic separation of the fan blade from the hub, which is highly undesirable.

It would be beneficial to provide a fan blade that can withstand the stress and high root loads that are often associated with an impact force caused by a blade out condition or a bird strike event.

### SUMMARY OF THE INVENTION

The subject invention is directed to a new and useful rotor blade for use in a gas turbine engine that provides reduced stress on the blades resulting from an impact force during a blade out condition or a bird strike event.

The novel rotor blade disclosed herein includes an airfoil portion and a unique integral dovetail root portion. The dovetail root portion is designed to accommodate the controlled movement of the blade within a shaped slot. Moreover, the dovetail root portion is adapted and configured to enable the blade to rotate within a shaped slot formed in a supporting hub of the engine about a center of rotation that extends parallel to a central axis of the hub in response to an impact force on the airfoil portion of the blade.

In accordance with a preferred embodiment of the subject invention, the dovetail root portion includes laterally opposed curved bearing faces. Preferably, the curved or rounded bearing faces have a common center of curvature that is in proximity of a lower surface of the root portion. The curved bearing faces are dimensioned and configured to facilitate the rotation of the root portion within the slot though an arc of at least about 4 degrees of angular rotation in either direction. Those skilled in the art will readily appreciate that the range of angular movement can vary depending upon the size or height of the blades, the number of blades that are associated with the hub, the relative circumferential spacing of adjacent blades within the hub and the broach angle of the attachment slot relative to the incidence angle.

A resilient or otherwise compliant under-root spacer is preferably provided within each of the shaped hub slots, below the root portion of the blade. It is envisioned that the under-root spacer can be attached to the root portion, attached to a surface of the hub slot or it can be separate from both the root and hub slot. The resilient under-root spacer is adapted and configured to provide a restoring force proportional to any rotational displacement of the blade within the shaped hub slot. The under-root spacer would also minimize rotation in the hub slot at low speeds and low loads, such as when the rotor is windmilling on the ground. Preferably, the under-root spacer is formed from silicone rubber or a similar resilient material able to withstand the operating conditions present in a gas turbine engine.

The subject invention is also directed to a gas turbine engine blade section that includes a hub having a central axis extending therethrough and having a plurality of circumferentially disposed axially extending shaped slots formed in an outer periphery thereof. The blade section further includes a plurality of circumferentially spaced blades, each blade having an airfoil portion and a dovetail root portion, wherein the dovetail root portion of each blade is received within a corresponding shaped slot such that the blade is able to rotate within that shaped slot about a center of rotation that extends parallel to the central axis of the hub in response to an impact force on the airfoil portion.

These and other features of the rotor blade of the subject invention and the manner in which it is employed will become more readily apparent to those having ordinary skill in the art from the following enabling description of the preferred embodiments of the subject invention taken in conjunction with the several drawings described below.

### BRIEF DESCRIPTION OF THE DRAWINGS

So that those skilled in the art will readily understand how to make and use the novel rotor blades of the subject invention without undue experimentation, embodiments thereof will be described in detail herein below with reference to certain figures, wherein:

FIG. 1 is a cross-sectional view of a gas turbine engine employing a rotor blade constructed in accordance with a preferred embodiment of the subject invention;

FIG. 2 is a perspective view of a disc with retention slots and a rotor blade supported in one of the slots;

FIG. 3 is an enlarged localized view of the dovetail root section of the rotor blade shown in FIG. 2;

FIG. 4 is cross-sectional view of the dovetail root section of the rotor blade disposed within the corresponding retention slot, as shown in FIG. 2; and

FIG. 5 is a cross-sectional view similar the view shown in FIG. 4, wherein the rotor blade is rotationally displaced within the retention slot about its enter of rotation as a result of an impact force on the airfoil portion of the blade.

### DETAILED DESCRIPTION OF PREFERRED EMBODIMENTS

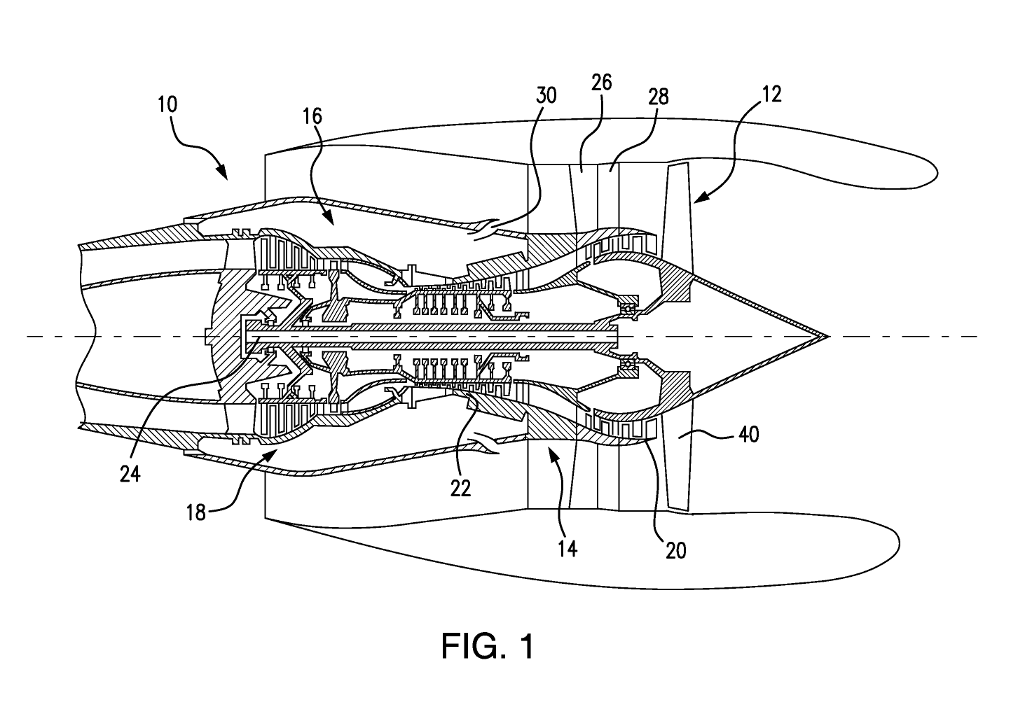

Referring now to the drawings wherein like reference numerals identify similar structural features or aspects of the subject invention, there is illustrated in FIG. 1 a cross-sectional view of gas turbine engine designated generally by reference numeral 10. Gas turbine engine 10 includes a turbofan 12, a compressor section 14 downstream from the turbofan 12, a combustion section 16 downstream from the compressor section 14, and a turbine section 18 downstream from the combustion section 16.

The compressor section 14 includes a low-pressure compressor 20 and a high-pressure compressor 22. Air is taken into the gas turbine engine 10 through the turbofan 12 as the turbofan spins about its axis. A portion of the inlet air taken in by the turbofan 12 is directed to compressor section 14 where it is compressed by a series of rotating blades and vanes associated with the low pressure compressor 20 and the high pressure compressor 22. The compressed air is from compressor section 14 is mixed with fuel, and then ignited in the combustor section 16. The combustion exhaust from combustion section 16 is directed to turbine section 18. Blades and vanes in turbine section 18 extract kinetic energy from the combustion exhaust to turn shaft 24 and provide power output for the gas turbine engine 10.

The portion of inlet air that is taken in through fan 12 and not directed through compressor section 14 is bypass air. The bypass air is directed through bypass duct 26 by guide vanes 28. The bypass air flows through an opening 30 in the engine casing to cool the combustor section 16, high pressure compressor 22 and turbine section 18. The turbofan 12 includes a plurality of fan blades 40.

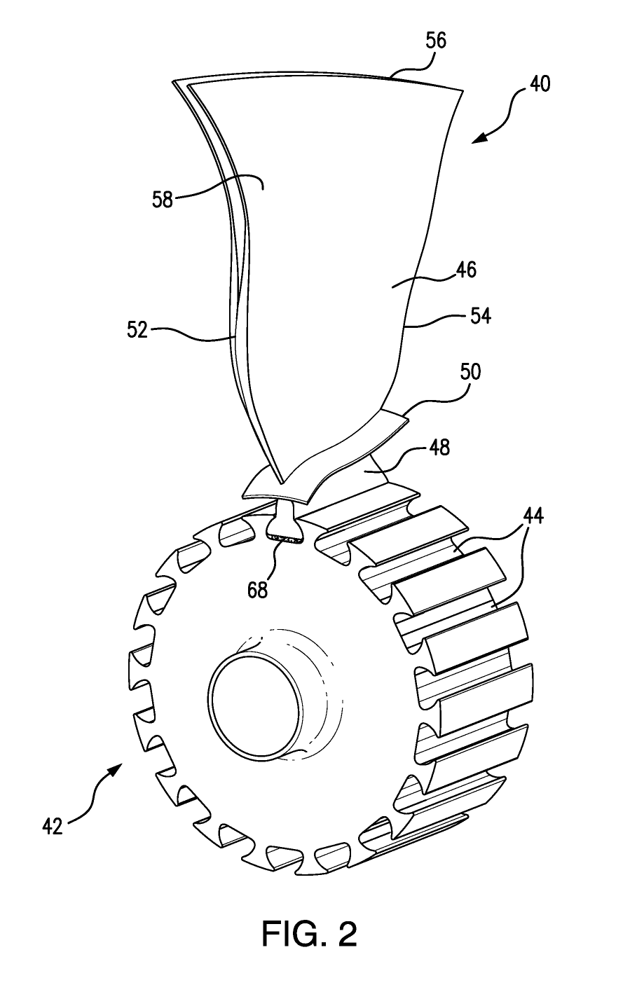

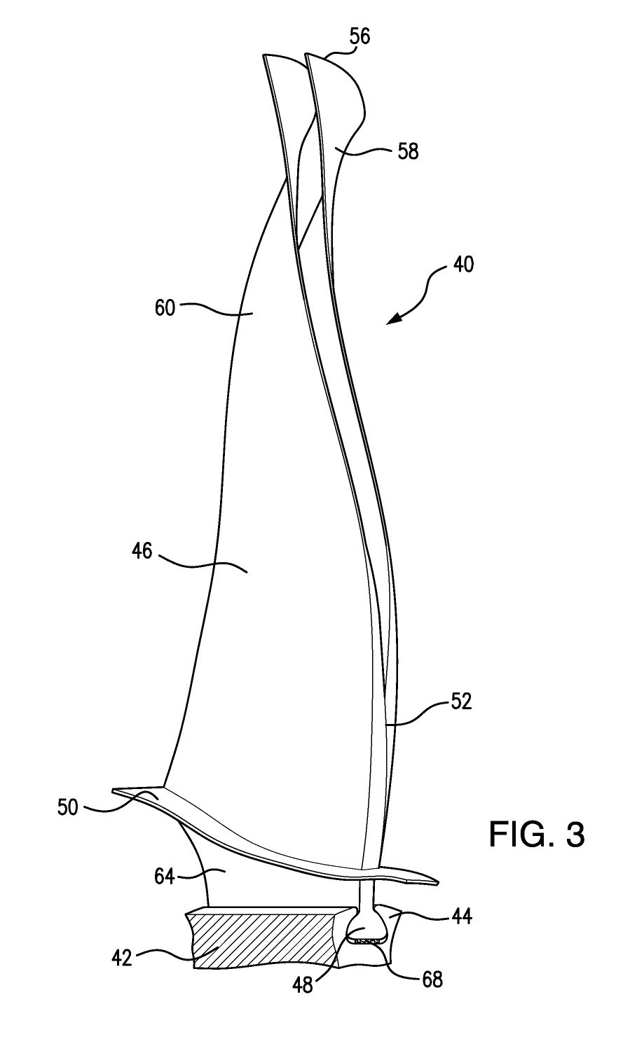

Referring to FIGS. 2 and 3, the fan blades 40 of turbofan 12 are operatively associated with a central hub 42. The hub 42 is constructed with a plurality of circumferentially spaced apart radially inwardly extending retention slots 44 for accommodating fan blades 40. Together, the hub 42 and fan blades 40 form a blade section of engine 10.

Each fan blade 40 includes an airfoil portion 46 and an integral dovetail root portion 48. The airfoil portion 46 may be unitary in construction or it can be bifurcated for improved efficiency as illustrated herein. An integral platform 50 is provided between the airfoil portion 46 and the root portion 48. The airfoil portion 46 has a leading edge 52, a trailing edge 54 and a free radially outermost tip 56. Functionally, the shape of the airfoil portion 46 defines a suction side 58 and pressure side 60 of the blade 40.

Unlike prior art fan blades wherein the dovetail root portion of the blade is relatively rigidly retained in a retention slot, as disclosed for example in U.S. Pat. No. 8,573,947 to Klinetob et al., the dovetail root portion 48 of the fan blade 40 disclosed herein is not rigidly retained it a retention slot. Instead, the dovetail root portion 48 is adapted and configured to enable the blade 40 to freely rotate in its retention slot 44, within a certain angular range. This angular rotation occurs about a center of rotation that extends parallel to a central axis of the hub 42. Consequently, in the event of an impact force on the airfoil portion 46 of the blade 40 from, for example, a blade out condition or a bird strike event, the blade 40 will be able to better withstand the resulting stress and high root loads that would have otherwise adversely affected prior art fan blades that were rigidly retained in a hub slot.

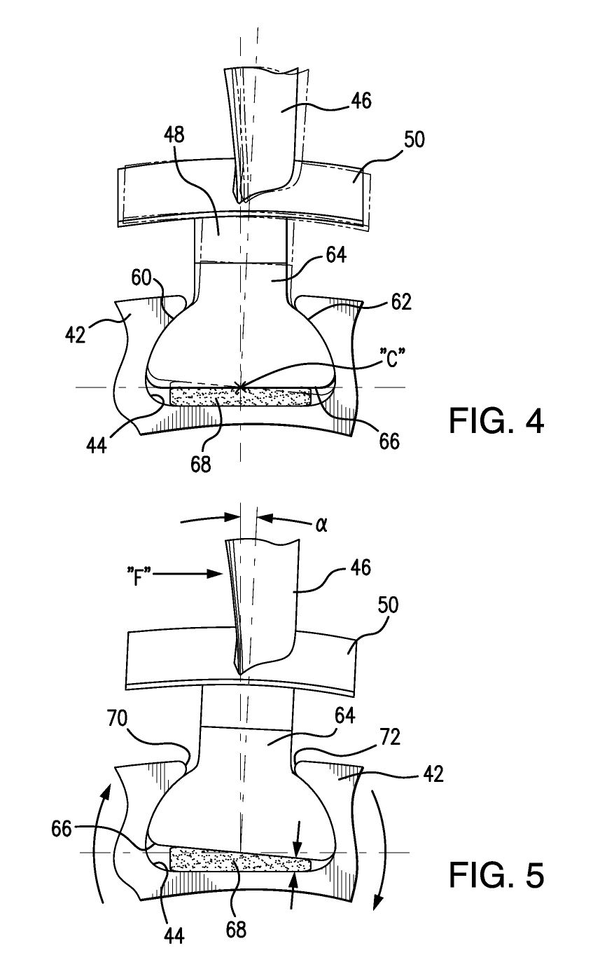

As best seen in FIG. 4, the dovetail root portion 48 of blade 40 includes laterally opposed curved bearing faces 60 and 62 that emanate from the neck 64 of the root and terminate at a generally planar undersurface 66. The curved bearing faces 60 and 62 have a common center of curvature “C” that defines the center of rotation of the blade 40 and coincides with the undersurface 66 of root portion 48. The curved bearing surfaces 60 and 62 interact with complementary curved wall surfaces 70 and 72 of retention slot 44. Together, the curved bearing surfaces 60, 62 of root portion 48 and the curved wall surfaces 70, 72 of retention slot 44 are dimensioned and configured to accommodate an angular blade rotation “α” of at least 4 degrees in either direction within the shaped retention slot 44.

Those skilled in the art will readily appreciate that the range of angular movement of the blade 40 within slot 42 can vary depending upon the size and shape of the retention slots 44 in hub 42, the size or height of the blades 40, the number of blades 40 that are associated with the hub 42 and the relative circumferential spacing of adjacent blades 40 within the hub 42. It should also be appreciated that the integral platform 50 can limit the extent of the angular rotation, and therefore the platform must be designed to accommodate an appropriate amount of motion. Furthermore, the platform should be designed to absorb energy associated with an impact force of the blade.

It is envisioned that the dovetail root portion 48 of blade 40 can be formed by forging or by partial forging and partial machining. For example, after forging the general shape of root portion 48, it can be machined to further refine the shape of the curved surfaces 60 and 62.

A resilient or otherwise compliant under-root spacer 68 is provided within each shaped retention slot 44. The under-root spacer 68 is adapted and configured to center the blade 40 in the retention slot 44 or otherwise provide a restoring force proportional to any rotational displacement of the blade 40 within the shaped retention slot 44. Essentially, the under-root spacer 68 absorbs the energy of the impact force on the airfoil portion 46 of the blade 40. In an alternative embodiment, the under-root spacer 68 could be designed to absorb energy from an impact and yield at a given force.

Preferably, the compliant under-root spacer 68 is formed from silicone rubber or a similar resilient material suitable for use in a gas turbine operating environment. It is envisioned that the under-root spacer 68 can be attached to the root portion 48 of blade 40, attached to a surface of the hub slot 44 or it can be separate from both the root portion 48 and hub slot 44.

As illustrated in FIG. 5, in the event of an impact force “F” acting on the airfoil portion 44 of fan blade 40 from a bird strike event or blade out condition, the dovetail root portion 48 will rotate laterally within retention slot 44 in the direction of the force vector. As such a time, the under-root spacer 68 will compress to absorb the energy of the impact force, and will provide a restoring force to return the fan blade 40 to a neutral centered position within retention slot 44. This will result in reduced stress on the fan blade and hub. In addition, the novel root structure will provide a more uniform stress on the dovetail portion, because the blades can balance themselves at different speeds and gas loads. Furthermore, the novel root structure can provide damping of first order vibratory blade motion through friction on the bearing faces.

While the subject invention has been shown and described with reference to preferred embodiments, those skilled in the art will readily appreciate that various changes and/or modifications may be made thereto without departing from the spirit and scope of the subject invention as defined by the appended claims.

What is claimed is:

1. A blade for use in a gas turbine engine: the blade comprising an airfoil portion and a dovetail root portion, wherein the dovetail root portion is dimensioned and configured to enable the blade to rotate within a shaped slot formed in a supporting hub of the engine about a center of rotation that extends parallel to a central axis of the hub in response to an impact force on the airfoil portion of the blade.

2. A blade as recited in claim 1, wherein the dovetail root portion includes lateral opposed curved bearing faces that have a common center of curvature.

3. A blade as recited in claim 2, wherein the curved bearing faces are dimensioned and configured to facilitate at least 4 degrees of angular rotation in either lateral direction within the shaped hub slot.

4. A blade as recited in claim 1, wherein a compliant under-root spacer is provided within the shaped hub slot.

5. A blade as recited in claim 4, wherein the under-root spacer is adapted and configured to provide a restoring force proportional to any rotational displacement of the blade within the shaped hub slot.

6. A blade as recited in claim 4, wherein the under-root spacer is formed from silicone rubber.

7. A blade as recited in claim 1, wherein the airfoil portion is formed integral with the dovetail root portion.

8. A gas turbine engine blade section comprising:
a) a hub having a central axis extending therethrough and having a plurality of circumferentially disposed axially extending shaped radial retention slots formed in an outer periphery thereof; and
b) a plurality of circumferentially spaced blades, each blade having an airfoil portion and a dovetail root portion, wherein the dovetail root portion of each blade is received within a corresponding retention slot such that the blade is able to rotate within that slot about a center of rotation that extends parallel to the central axis of the hub in response to an impact force on the airfoil portion.

9. A gas turbine engine blade section as recited in claim 8, wherein the dovetail root portion of each blade has curved bearing faces configured to mate with complementary shaped slot surfaces.

10. A gas turbine engine blade section as recited in claim 9, wherein the curved bearing faces have a common center of curvature so the blade can rotate within in the slot.

11. A gas turbine engine blade section as recited in claim 9, wherein the curved bearing faces are dimensioned and configured to facilitate at least 4 degrees of angular rotation in either lateral direction within the slot.

12. A gas turbine engine blade section as recited in claim 9, wherein a resilient under-root spacer is provided within the slot to provide a restoring force proportional to any rotational displacement of the blade within the slot.

13. A gas turbine engine blade section as recited in claim 9, wherein the blades are each configured for self-balancing at different speeds and gas loads through rotation about the dovetail root portions to provide relatively uniform stress on the dovetail root portions.

14. A gas turbine engine blade section as recited in claim 9, wherein the dovetail root portion of each blade is configured to provide damping of first order vibratory blade motion.

15. A gas turbine engine having a blade section, the blade section comprising:
a) a hub having a central axis extending therethrough and having a plurality of circumferentially disposed axially extending hub slots formed in an outer periphery thereof;
b) a plurality of circumferentially spaced blades, each blade having an airfoil portion and an integral dovetail root portion, wherein the dovetail root portion of each blade is received within a corresponding hub slot such that the blade is able to rotate within that hub slot about a center of rotation that extends parallel to the central axis of the hub in response to an impact force on the airfoil portion, and wherein a resilient under-root spacer is provided within each hub slot to absorb the energy of the impact force on the airfoil portion.

16. A gas turbine engine as recited in claim 15, wherein the dovetail root portion of each blade has curved bearing faces configured to mate with complementary hub slot surfaces.

17. A gas turbine engine as recited in claim 16, wherein the curved bearing faces have a common center of curvature so the blade can rotate freely in the hub slot.

18. A gas turbine engine as recited in claim 17, wherein the curved bearing faces are dimensioned and configured to facilitate at least 4 degrees of angular rotation within the slot.

19. A gas turbine engine as recited in claim 15 wherein the under-root spacer is formed from silicone rubber.

20. A gas turbine engine as recited in claim 15, wherein the under-root spacer is adapted and configured to provide a restoring force proportional to rotational displacement of the blade within the slot.
